(19) United States
(12) Patent Application Publication
(10) Pub. No.: US 2012/0156370 A1
(43) Pub. Date: Jun. 21, 2012

(54) PROCESS FOR THE INFILTRATION OF POROUS CERAMIC COMPONENTS

(75) Inventors: Christoph Tontrup, Alzenau (DE); Wolfgang Lortz, Waechtersbach (DE); Gabriele Perlet, Grosskrotzenburg (DE)

(73) Assignee: Evonik Degussa GmbH, Essen (DE)

(21) Appl. No.: 13/391,953

(22) PCT Filed: Sep. 15, 2010
(86) PCT No.: PCT/EP10/63524

§ 371 Date: Feb. 23, 2012

(30) Foreign Application Priority Data
Oct. 14, 2009 (DE) 102009045698.8

(51) Int. Cl. B05D 1/12

(52) U.S. Cl. 427/201; 427/180

(57) ABSTRACT

Process for the infiltration of porous ceramic components, in which a dispersion containing metal oxide particles and having a metal oxide content of at least 30% by weight, based on the dispersion, is used, where the particle size distribution d₅₀ of the metal oxide particles is not more than 200 nm.

The invention relates to a process for the infiltration of ceramic components by means of a highly filled dispersion containing metal oxide particles.

The infiltration of porous ceramic components, in particular components for use in high-temperature applications (refractive ceramics), is known. This is intended to reduce the porosity of these components and thus increase the corrosion resistance, the oxidation resistance and possibly also the strength of these components.
The prior art describes the infiltration of ceramic components with carbon-containing substances. However, a ceramic component which has been infiltrated in this way has disadvantages in terms of thermal stability and oxidation stability.

The infiltration of porous ceramic components can also be carried out using inorganic melts or solutions of metal salts. Infiltration with salt melts is complicated and costly. When metal salt solutions, for example solutions which form refractive oxides on firing, are used, the solvent is firstly evaporated and the metal salt is subsequently converted into the oxide. In general, only very small amounts of oxide can be formed in this way.

It was therefore an object of the present invention to provide a process for the infiltration of ceramic components, which does not have the disadvantages of the prior art.

The invention provides a process for the infiltration of porous ceramic components, in particular components for use in high-temperature applications, e.g. refractive components, in which a dispersion containing metal oxide particles and having a metal oxide content of at least 30% by weight, preferably from 30 to 70% by weight, particularly preferably from 40 to 60% by weight, based on the dispersion, is used, where the particle size distribution d₅₀ of the metal oxide particles determined by means of laser light scattering is not more than 200 nm, preferably from 50 to 100 nm.

For the purposes of the present invention, pore ceramic components are components having a pore diameter of from 0.5 to 100 μm.

One suitable method of determining the particle size distribution in this size range is laser light scattering. If the particles are present as aggregated species, the particle size distribution corresponds to an aggregate size distribution.

The d₅₀ is the volume-based value. It means that 50% of the particles are smaller than the value indicated. Correspondingly, a d₉₅ means that 95% of the particles are smaller than the value indicated.

It has been found that the infiltration is particularly efficient when the proportion of coarser particles is low. Preference is therefore given to using dispersions in which the metal oxide particles have a particle size distribution d₉₅ of not more than 250 nm, particularly preferably from 100 to 200 nm.

Furthermore, it has been found that it can have an advantageous effect on the infiltration for the metal oxide particles to be present at least partly, better virtually completely, in aggregated form. Such metal oxide particles can be obtained, for example, by flame oxidation or flame hydrolysis processes.

In addition, the invention further provides a process in which, in contrast to the process described hitherto for the infiltration of porous ceramic components, a dispersion which has a coarse fraction and a fine fraction of metal oxide particles is used. The process is characterized in that a dispersion which
a) has a metal oxide content of at least 30% by weight, preferably from 40 to 80% by weight, very particularly preferably from 50 to 70% by weight, in each case based on the dispersion,
b) consists of a fine fraction and a coarse fraction of particles of in each case one or more metal oxides,
   b1) the fine fraction has a particle size distribution d₅₀ of not more than 200 nm, preferably from 50 to 100 nm, and
   b2) the coarse fraction has a particle size distribution d₅₀ of from 0.3 to 5 μm, preferably from 0.5 to 3 μm, and
   b3) the weight ratio of fine fraction to coarse fraction is from 10:90 to 80:20, preferably from 40:60 to 60:40,
   is used.

In this process, too, it can be advantageous to choose the fine fraction so that the metal oxide particles have a particle size distribution d₉₅ of not more than 250 nm, particularly preferably from 100 to 200 nm.
Correspondingly, it can be advantageous in the case of the coarse fraction for the particles to have a diameter which does not exceed 5 μm. The metal oxides of the coarse and fine fractions can be either identical or different.

When a dispersion containing a fine fraction and a coarse fraction is used, the particle size distribution d₅₀ or d₉₅ can preferably be determined by means of dynamic laser light scattering or counting of transmission electron micrographs (image analysis).

The metal oxide particles are preferably selected from the group consisting of aluminium oxide, calcium oxide, chromium oxide, magnesium oxide, silicon dioxide, titanium dioxide, zirconium dioxide, yttrium oxide, mixed oxides of the abovementioned metal oxides and physical mixtures of the abovementioned metal oxides. Silicon dioxide as semimetal oxide is for the purposes of the present invention considered to be a metal oxide. The BET surface area of these metal oxides is preferably from 20 to 200 m²/g, particularly preferably from 40 to 100 m²/g.

In general, a dispersion which is essentially free of binders is used in the processes of the invention.

On the other hand, the dispersion used in the processes of the invention can contain wetting agents known to those skilled in the art.

The pH of the dispersions used in the processes of the invention can be varied within wide limits. In general, the pH can be in the range from 2 to 12. Depending on the type of metal oxide and the pH, different zeta potentials are obtained. The zeta potential is a measure of the surface charge of the particles. Depending on the surface charge of the porous, ceramic component, the penetration depth can also be controlled via the zeta potential of the metal oxide particles in the dispersion. If the porous, ceramic component has a negative surface charge at the pH of the dispersion, cationically charged metal oxide particles lead to only a small penetration depth, i.e. only a region close to the surface is infiltrated. On the other hand, in the case of negatively charged metal oxide particles, a higher penetration depth can be achieved under these conditions.

The infiltration can be effected by means of steeping, dipping, brushing, spraying and/or vacuum-pressure infiltration. The infiltration can be followed by a drying step and/or after-firing step.

A dispersion which can preferably be used in the process of the invention is a dispersion which has
a) aggregated titanium dioxide particles having
   a1) a BET surface area of from 20 to 100 m²/g, particularly preferably from 50 to 90 m²/g,
   a2) a titanium dioxide content, based on the dispersion, of from 35 to 45% by weight as metal oxide particles,
b) a pH of from 5 to 7 and a
c) viscosity at 20° C. and a shear rate of 100 s⁻¹ of less than 1000 mPas, preferably from 2 to 200 mPas.

Furthermore, it can also be preferred to use a dispersion which
a) contains aggregated aluminium oxide particles having
   a1) a BET surface area of from 40 to 130 m²/g, particularly preferably from 60 to 100 m²/g, and
   a2) a content, based on the dispersion, of from 30 to 40% by weight
      as metal oxide particles and
b) has a pH of from 3 to 5 and a
c) viscosity at 20° C. and a shear rate of 100 s⁻¹ of less than 500 mPas, preferably from 2 to 100 mPas.

Furthermore, it can also be preferred to use a dispersion which
a) contains aggregated aluminium oxide particles having
   a1) a BET surface area of from 40 to 130 m²/g, preferably from 60 to 100 m²/g,
   a2) a content, based on the dispersion, of from 35 to 55% by weight
      as metal oxide particles and
b) has a pH of from 6 to 9 and
c) a viscosity at 20° C. and a shear rate of 100 s⁻¹ of less than 500 mPas, preferably from 2 to 250 mPas.

Furthermore, it can also be preferred to use a dispersion which
a) contains aggregated aluminium oxide particles having
   a1) a BET surface area of from 40 to 130 m²/g, preferably from 60 to 100 m²/g,
   a2) a content, based on the dispersion, of from 55 to 65% by weight
      as metal oxide particles and
b) one or more at least dibasic hydroxy carboxylic acids or a salt thereof dissolved in the dispersion and at least one salt of a di(alkali metal) hydrogenphosphate and/or alkali metal dihydrogenphosphate, in each case independently of one another in an amount of 0.3-3×10⁻⁶ mol/m² of specific aluminium oxide surface area, and
c) has a pH of from 6 to 10 and
d) a viscosity at 20° C. and a shear rate of 100 s⁻¹ of less than 2000 mPas, preferably from 100 to 750 mPas.

Furthermore, it can also be preferred to use a dispersion which
a) contains aggregated zirconium dioxide particles or stabilized zirconium dioxide particles having
   a1) a BET surface area of from 20 to 70 m²/g, preferably from 30 to 50 m²/g,
   a2) a content, based on the dispersion, of from 45 to 55% by weight
      as metal oxide particles and
b) has a pH of from 8 to 11 and
c) a viscosity at 20° C. and a shear rate of 100 s⁻¹ of less than 500 mPas, preferably from 2 to 50 mPas.

Finally, it is possible to use an aluminium oxide dispersion which
a) has a content of aluminium oxide of from 60 to 85% by weight,
b) where the weight ratio of fine fraction to coarse fraction is from 10:90 to 80:20,
c) the particle size distribution d₅₀ of the fine fraction present in aggregated form is from 60 to 100 nm and the BET surface area is from 40 to 130 m²/g, preferably from 60 to 100 m²/g, and
d) the particle size distribution d₅₀ of the coarse fraction present as isolated individual particles is from 300 to 1000 nm.

The invention further provides ceramic components which can be obtained by means of the processes of the invention. These include, for example, slider plates, immersed outlets, bricks, plugs, flushing cones, shadow tubes, outlet nozzles, membranes, thermal insulation materials and heat shields.

1. A process for infiltrating a porous ceramic component, comprising:
infiltrating the porous ceramic component with a dispersion comprising metal oxide particles,
wherein a metal oxide content of the dispersion is at least 30% by weight, and
a particle size distribution d₅₀ of the metal oxide particles is not more than 200 nm.

2. The process of claim 1,
wherein a particle size distribution d₉₅ is not more than 250 nm.

3. The process of claim 1,
wherein the metal oxide particles are present at least partly in aggregated form.

4. A process for infiltrating a porous ceramic component, comprising:
infiltrating the porous ceramic component with a dispersion comprising a fine fraction of metal oxide particles and a coarse fraction of metal oxide particles,
wherein a metal oxide content of the dispersion is at least 30% by weight,
the fine fraction has a particle size distribution d₅₀ of not more than 200 nm
the coarse fraction has a particle size distribution d₅₀ of from 0.3 to 5 μm, and
a weight ratio of the fine fraction to the coarse fraction is from 10:90 to 80:20.

5. The process of claim 1,
wherein the metal oxide particles comprise at least one metal oxide selected from the group consisting of aluminium oxide, calcium oxide, chromium oxide, magnesium oxide, silicon dioxide, titanium dioxide, zirconium dioxide, yttrium oxide, a mixed oxide of the abovementioned metal oxides and a physical mixture of the abovementioned metal oxides.

6. The process of claim 1, wherein the dispersion is free of binders.

7. The process of claim 1, wherein the dispersion further comprises a wetting agent.

8. The process of claim 1, wherein a pH of the dispersion is from 2 to 12.

9. The process of claim 1, wherein the infiltrating comprises steeping, dipping, brushing, spraying, vacuum-pressure infiltration, or a combination thereof.

10. The process of claim 1,
wherein the dispersion comprises from 35 to 45% by weight aggregated titanium dioxide particles having a BET surface area of from 20 to 100 m²/g,
a pH of the dispersion is from 5 to 7, and
a viscosity of the dispersion, at 20° C. and a shear rate of 100 s⁻¹ is less than 1000 mPas.

11. The process of claim 1,
wherein the dispersion comprises from 30 to 40% by weight of aggregated aluminium oxide particles having a BET surface area of from 40 to 130 m²/g,
a pH of the dispersion is from 3 to 5 and
a viscosity of the dispersion, at 20° C. and a shear rate of 100 s⁻¹₁ is less than 500 mPas.

12. The process of claim 1,
wherein the dispersion comprises from 35 to 55% by weight of aggregated aluminium oxide particles having a BET surface area of from 40 to 130 m²/g,
a pH of the dispersion is from 6 to 9 and
a viscosity of the dispersion, at 20° C. and a shear rate of 100 s⁻¹ is less than 500 mPas.

13. The process of claim 1,
wherein the dispersion comprises from 55 to 65% by weight of aggregated aluminium oxide particles having a BET surface area of from 40 to 130 m²/g,
the dispersion further comprises an at least dibasic hydroxy carboxylic acid or a salt thereof dissolved in the dispersion in an amount of from 0.3×10⁻⁶ to 3×10⁻⁶ mol/m² of specific aluminium oxide surface area,
the dispersion further comprises a salt of a di(alkali metal) hydrogenphosphate, an alkali metal dihydrogenphosphate, or both in an amount of from 0.3×10⁻⁶ to 3×10⁻⁶ mol/m² of specific aluminium oxide surface area,
a pH of the dispersion is from 6 to 10, and
a viscosity of the dispersion, at 20° C. and a shear rate of 100 s⁻¹ is less than 2000 mPas.

14. The process of claim 1,
wherein the dispersion comprises from 45 to 55% by weight of aggregated zirconium dioxide particles or stabilized zirconium dioxide particles having a BET surface area of from 20 to 70 m²/g,
a pH of the dispersion is from 8 to 11, and
a viscosity of the dispersion, at 20° C. and a shear rate of 100 s⁻¹ is less than 500 mPas.

15. The process of claim 4,
wherein the dispersion is an aluminium oxide dispersion, comprising from 60 to 85% by weight of aluminium oxide,
wherein at least a portion of the fine fraction is present as aggregated particles,
at least a portion of the coarse fraction is present as isolated individual particles,
the particle size distribution d₅₀ of the fine fraction present as aggregated particles is from 60 to 100 nm.
a BET surface area of the fine fraction is from 40 to 130 m²/g, and
the particle size distribution d₅₀ of the coarse fraction present as isolated individual particles is from 300 to 1000 nm.

16. A ceramic component obtained by a process comprising the process of claim 1.

17. The process of claim 2, wherein the particle size distribution d₉₅ is not more than 200 nm.

18. The process of claim 4,
wherein the fine fraction has a particle size distribution d₅₀ of from 50 to 100 nm.

19. The process of claim 4,
wherein the coarse fraction has a particle size distribution d₅₀ of from 0.5 to 3 μm.

20. The process of claim 15,
wherein the BET surface area of the fine fraction is from 60 to 100 m²/g.
